(19) United States
(12) Patent Application Publication
(10) Pub. No.: US 2020/0391938 A1
(43) Pub. Date: Dec. 17, 2020

(54) LOCKING RING FOR HOLDING TRASH CAN LINERS IN PLACE

(71) Applicant: Thomas D. Frey, Eatonton, GA (US)

(72) Inventor: Thomas D. Frey, Eatonton, GA (US)

(21) Appl. No.: 16/437,373

(22) Filed: Jun. 11, 2019

(51) Int. Cl. B65F 1/06

(52) U.S. Cl. CPC B65F 1/06

(57) ABSTRACT

A trash container liner locking ring is provided. The locking ring is dimensioned and adapted to operatively associate with an entirety of a lip of a container, the locking ring having an arcuate body with an inner curvature defining a U-shaped cavity. The locking ring also provides a cavity protrusion that protrudes into the U-shaped cavity so when the cavity receives the lip, the cavity protrusion is located underneath an overhang of the lip, thereby sandwiching a liner of the container between the lip and the locking ring.

### BACKGROUND OF THE INVENTION

The present invention relates to containers and, more particularly, to a locking ring for holding a liner of a trash container in place.

Trash containers and receptacles typically have liners that too frequently fall inside the container when trash is dropped into it. This makes it necessary to pull the liner out, which requires dealing in close proximity with possibly smelly and messy trash. The individual would then be urged to hang the liner over the lip of the container, which, by itself, can again fall back into the trash container. This is inconvenient as well as unsanitary. Existing products to address this issue are bands placed around the container. Such bands hold the liner in place but do not provide enough friction force to hold the liner well enough especially under the weight of a lot a trash, and so the liner can still fall inside the container when heavier items are inserted into the container.

As can be seen, there is a need for a locking ring for holding liners of containers in place. The locking ring securely holds the liner in place by locking the entire liner opening around the container lip, keeping the liner from falling inside the container in a much more secure manner than the above-mentioned bands.

### SUMMARY OF THE INVENTION

In one aspect of the present invention, a container liner locking ring includes the following: a U-shaped body having an inner curvature defining a channel cavity; and a cavity protrusion extending from the inner curvature into the channel cavity adjacent to a mouth of the U-shape body, wherein the U-shaped body defines a ring periphery of a planar circle shape or a planar rectangular shape, and wherein the cavity protrusion extends approximately a quarter of a distance from a first leg of the U-shaped body to an opposing second leg of the U-shaped body.

In another aspect of the present invention, a method for securing a container liner to a container liner using the above-mentioned locking ring includes the following: providing a container having an opening defined by a lip, wherein the lip defines a lip periphery coextensive as the ring periphery; providing a liner dimensioned for the container; overlapping a portion of the liner over the lip; providing said locking ring; and snapping said locking over the lip so as to sandwich said portion of liner, and wherein the cavity protrusion is disposed underneath a portion of the lip, wherein the portion of the lip is an overhang extending away from the container.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is an exploded view of an exemplary embodiment of the present invention;

FIG. 3 is a profile view of an exemplary embodiment of the present invention;

FIG. 4 is a bottom perspective view of an exemplary embodiment of the present invention; and

FIG. 5 is a perspective section view of an exemplary embodiment of the present invention, taken along line 5-5 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a locking ring dimensioned and adapted to operatively associate with an entirety of a lip of a container, the locking ring having an arcuate body with an inner curvature defining a U-shaped cavity. The locking ring also provides a cavity protrusion that protrudes into the U-shaped cavity so when the cavity receives the lip, the cavity protrusion is located underneath an external (to the container) overhang 22 of the lip, thereby sandwiching the liner to the lip by way of the locking ring.

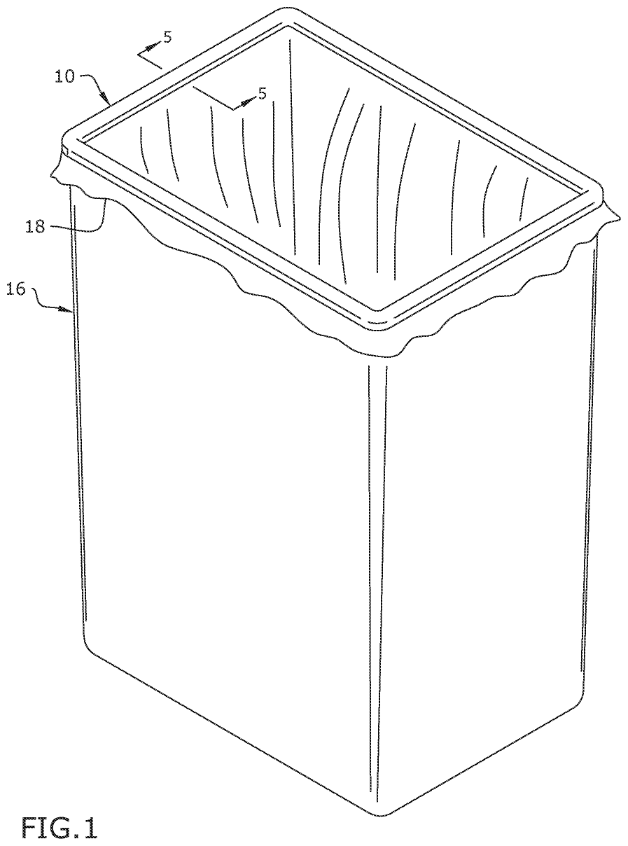

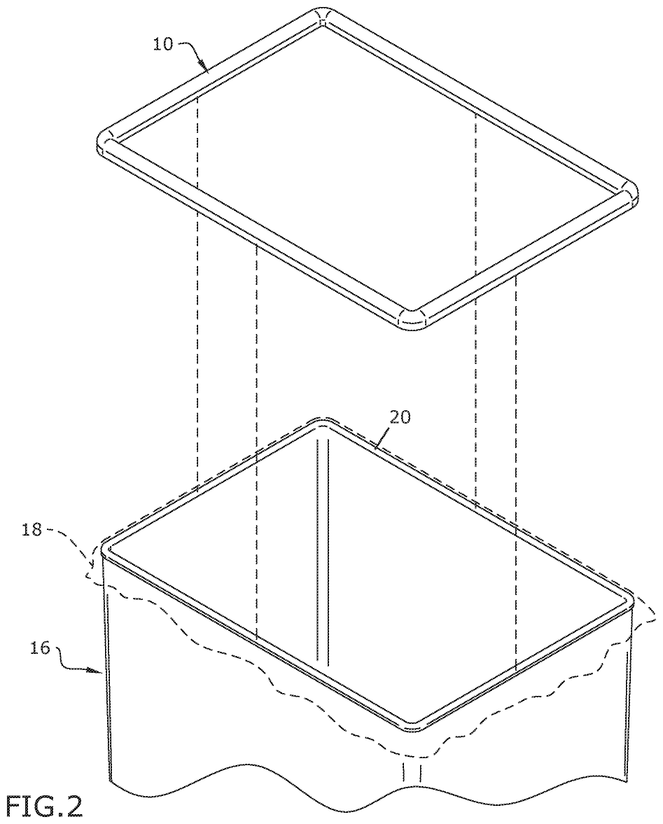

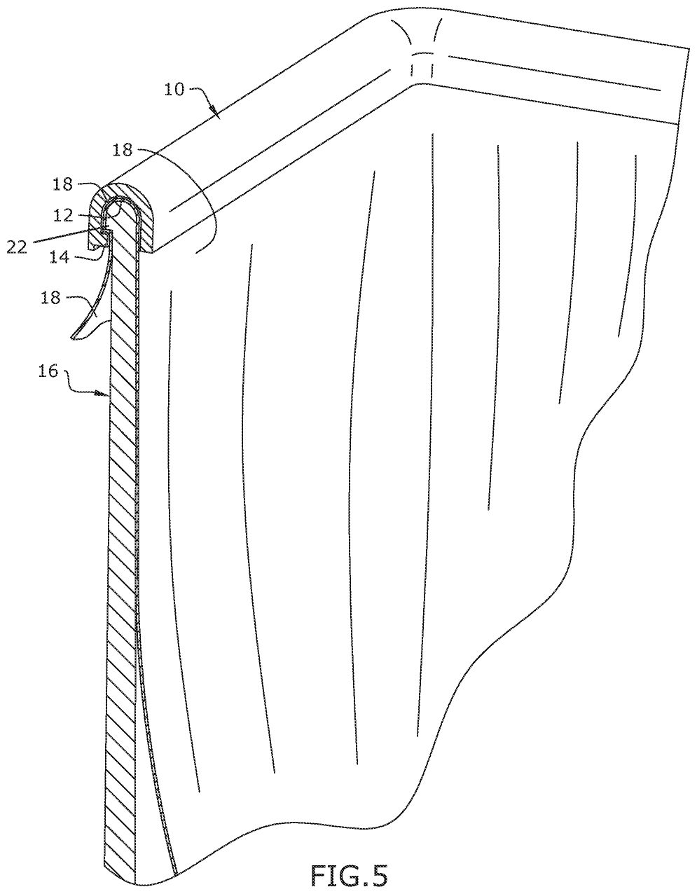

Referring to FIGS. 1 through 5, the present invention may include a locking ring 10 for retaining a liner of a container in place. The locking ring 10 may be made of various materials, including but not limited to injection-molded plastic. The locking ring 10 may be dimensioned and adapted to have an overall circular, rectangular, or other shape so as to operatively engage an entirety of a lip 20 of a container 16.

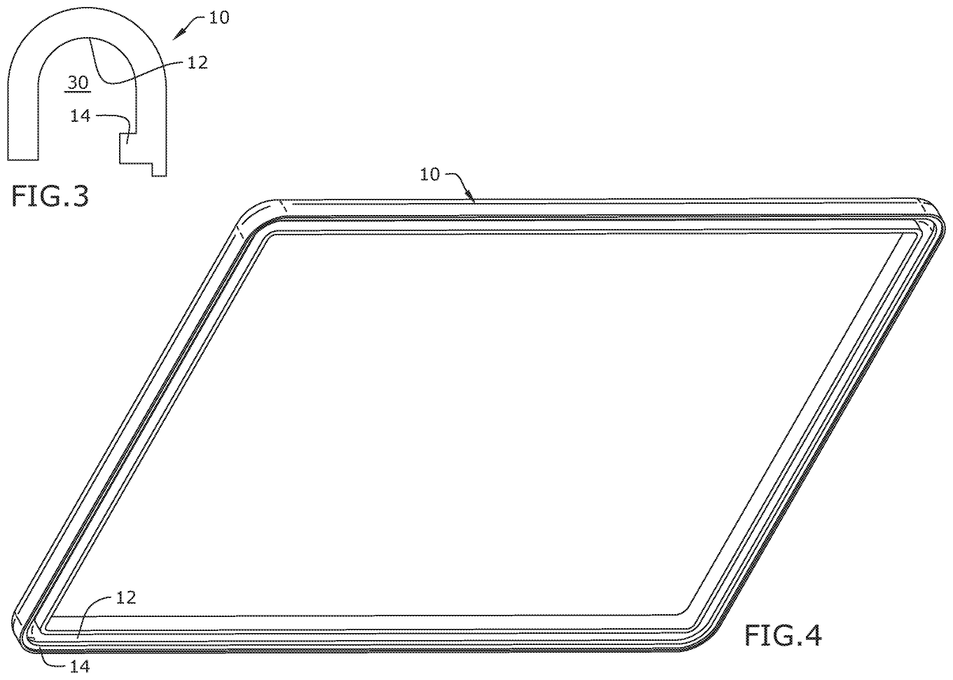

The underside of the locking ring 10 may be U-shaped having an inner curvature 12 defining a cavity 30 or channel running the entire length of the locking ring 10. A cavity protrusion 14 may extend from the inner curvature 12 so as to extending into the cavity 30 adjacent to a mouth of the U-shape, as illustrated in FIG. 3. The cavity protrusion 14 may extend less than half of the width of the cavity 30 so as to facilitate receiving the entirety of the container lip 20. In certain embodiments, the cavity protrusion 14 extends approximately a quarter of a distance from a first leg of the U-shaped body to an opposing second leg of the U-shaped body, meaning the cavity protrusion 14 extends between an eighth to three-eighths of said distance. The cavity 30 may be dimensioned and adapted so that the inner curvature 12 abuts an outer periphery of a lip 20 of a container 16, while the cavity protrusion 14 is disposed along, adjacent or against a lower portion of an overhang 22 of the lip 20, as illustrated in FIG. 5. The first and second legs may be approximately three-eighths to five-eighths. The length of each leg may be between one-quarter to one-half of an inch in length. The cavity protrusion 14 may extend for approximately one-thirty-seconds to one-eighth of an inch.

A method of using the present invention may include the following. The locking ring 10 disclosed above may be provided. A user may insert the liner 18 or bag into the container 16 so that liner 18 overlaps the lip 20 of the container 16. The locking ring 10 then simply locks onto the lip 20 of the container 16 by the user pressing down on the locking ring 10, thereby sandwiching a portion of the liner 18 against the container lip 20. The locking ring 10 secures the liner 18 with pressure around the entire lip 20 of the container 16, including under said overhang 22. When the liner 18 is full the locking ring 10 may be removed to allow for the removal of the liner 18 for re-installation.

It should be understood, of course, that the foregoing relates to exemplary embodiments of the invention and that modifications may be made without departing from the spirit and scope of the invention as set forth in the following claims.

What is claimed is:

1. A container liner locking ring, comprising:
a U-shaped body having an inner curvature defining a channel cavity; and
a cavity protrusion extending from the inner curvature into the channel cavity adjacent to a mouth of the U-shape body.

2. The container liner locking ring of claim 1, wherein the U-shaped body defines a ring periphery of a planar circle shape or a planar rectangular shape.

3. The container liner locking ring of claim 2, wherein the cavity protrusion extends approximately a quarter of a distance from a first leg of the U-shaped body to an opposing second leg of the U-shaped body.

4. The container liner locking ring of claim 3, wherein the first and second legs are spaced apart approximately two-quarters of an inch, wherein each leg is approximately three-eighth of an inch in length, and wherein the cavity protrusion extends for approximately one-sixteenth of an inch.

5. A method for securing a container liner to a container liner using the locking ring of claim 3, comprising:
providing a container having an opening defined by a lip, wherein the lip defines a lip periphery coextensive as the ring periphery;
providing a liner dimensioned for the container;
overlapping a portion of the liner over the lip;
providing said locking ring; and
snapping said locking over the lip so as to sandwich said portion of liner, and wherein the cavity protrusion is disposed underneath a portion of the lip.

6. The method of claim 5, wherein the portion of the lip is an overhang extending away from the container.
